(19) United States
(12) Patent Application Publication
(10) Pub. No.: US 2004/0136850 A1
(43) Pub. Date: Jul. 15, 2004

(54) Dual port unit pump injector, and engine efficiency methods

(76) Inventors: Kenneth H Klopfer, East Hartland, CT (US); Mark Duquette, Andover, CT (US)

Correspondence Address: ALIX YALE & RISTAS LLP, 750 MAIN STREET, SUITE 1400, HARTFORD, CT, 06103, US

(21) Appl. No.: 10/475,255

(22) PCT Filed: Apr. 26, 2002
(86) PCT No.: PCT/US02/13205

(51) Int. Cl. F04B 7/06; F02M 37/04

(52) U.S. Cl. 417/500; 123/501

(57) ABSTRACT

A unit pump (10) is provided with a bleed port (12) spaced from the main injection port (14). The bleed port (12) improves the rate shape of injection through an associated fuel injector by slowing the initial rate of injection. The bleed port (12) permits shifting of the engine speed at which speed advance occurs. The bleed port (12) also flattens the fuel backup curve. Altering the cross section flow area (18) of the bleed port, axial spacing between the bleed port and inlet port (20) permit the designer to vary (or even eliminate) the impact of the bleed port (12) on the unit pump (10) performance.

### BACKGROUND OF THE INVENTION

1. Field of the Invention

The invention relates to fuel metering control in a unit pump or unit injector designed to inject fuel pulses of variable quantity into the cylinder of an internal combustion engine and, more particularly, to refinements of the inlet port that improve the shape and timing of the injected fuel pulses.

2. Description of the Related Art

Historically, unit pumps and unit injectors for internal combustion engines have been simple, low cost fuel systems with few options and little flexibility. Controlling the quantity and timing of each injection pulse have been difficult to implement. As the need for higher engine efficiency and pollution abatement have increased, it has become increasingly evident that there is a need to control not only the quantity of fuel injected and the timing of injection but also the rate shape (quantity of fuel injected per unit of time over the course of an injection pulse) of each injection pulse.

The prior art discloses various methods for controlling the quantity of fuel injected by altering the exterior profile of a unit pump plunger. Providing a circumferential surface of the pump plunger in the form of a circumferential helix permits adjustment of injection duration and timing by rotation of the pumping plunger relative to the fuel inlet port defined by the unit pump body (also known as the fill/spill port). The helix has an upper profile, the axial position of which determines when the inlet port is completely covered and a lower profile, the axial position of which determines when the inlet port will be uncovered. The plunger is typically rotated by means of a control arm connected to a control rack. During each pumping stroke of the plunger, the circumferential helix closes a fuel inlet port to define a sealed pumping chamber for generating a pulse of high-pressure fuel. As long as the inlet port remains covered by the helix, pressure in the pumping chamber increases until the pressure is sufficient to hydraulically actuate (unseat) a needle valve in the injector, which permits pressurized fuel to be injected into the combustion chamber of an engine cylinder.

Thus, start of injection (SOI) is determined by the accumulation of sufficient pressure in the unit pump to unseat the needle valve in the injector. The end of injection (EOI) is determined by release of pressure in the pumping chamber caused by opening of the inlet port by the lower profile of the helix. Opening the inlet port relieves pressure in the pumping chamber by hydraulically connecting the pumping chamber to the inlet port. The pressure in the pumping chamber falls below a pressure that will allow closure of the needle valve, which consequently closes, ending the injection event.

It will be understood that the shape of the helix surrounding the pumping plunger, e.g., the axial distance between the upper and lower profiles of the helix, determines injection duration and, by that, the quantity of fuel injected. The axial position of the upper profile helps to determine SOI, with an upper profile extending in the direction of plunger movement advancing SOI. Rotation of the pumping plunger within the bore varies the timing and duration of injection by bringing different portions of the helix into axial alignment with the inlet port as is known in the art.

It will also be apparent that the quantity of fuel injected is dependent not only upon the duration of injection but also upon the volumetric pumping efficiency of the unit pump. It is known that unit pump efficiency is inversely related to engine speed above, for example, 1000 rpm. In other words, peak-pumping efficiency occurs at approximately 1000 rpm and decreases for the remainder of the engine rpm range. This causes a phenomenon called “fuel backup” in which greater quantities of fuel are injected at lower rpm's during reduction of engine speed from, for example rated speed to peak torque. This fuel backup has an adverse effect on emissions. Thus, there is a need in the art for modifications to a unit pump, which flatten the fuel delivery curve over an extended rpm range.

Another phenomenon called “speed advance” is caused by hydraulic interaction between the unit pump and the needle valve of the associated unit injector. For example, up to a particular engine rpm, the first hydraulic pressure wave generated by the unit pump is insufficient to open the needle valve of the unit injector. Instead, this first hydraulic pressure wave is reflected and reinforced by a second hydraulic pressure wave, which now has sufficient energy to open the needle valve in the unit injector. Above this engine rpm, higher plunger velocities produce a stronger pumping event and, as a result, the first pump-generated pressure wave has enough energy to open the needle valve of the injector. It will be understood that below this critical “speed advance” engine rpm, start of injection (SOI) is delayed by the need to reflect and reinforce the first pump-generated pressure wave. Subsequent to this critical engine rpm, the first pressure wave opens the needle valve, causing a phenomenon known as “speed advance” where SOI occurs up to several degrees of engine rotation sooner than below the critical engine rpm.

It will be apparent that if such an abrupt shift in the timing of an injection event relative to engine rotation occurs at an undesirable engine speed it will have a tendency to adversely influence control of combustion, with a concomitant increase in emissions from the combustion. For example, when the “speed advance” occurs at or near an emissions test point, i.e., max torque or rated speed, it seriously complicates the task of meeting emissions requirements for that test point. There is a need in the art to shift the occurrence of the “speed advance” to an engine rpm that enhances SOI timing and emissions compliance.

Precise control of fuel delivery at least over a range of engine speeds and load factors is essential to meeting stringent efficiency and emissions requirements. It is known that the shape of a fuel injection pulse is related to emissions of certain pollutants such as oxides of Nitrogen (NOₓ). It is known that a slower initial rate of injection reduces emissions of NOₓ. The most desirable shape for the end of an injection pulse is an abrupt shutoff. Thus, there is a need in the art for more precise control over the shape of each fuel injection pulse and, more particularly, to shape a fuel injection pulse that has a slower initial rate of injection and an abrupt cutoff at the end of the injection pulse.

### SUMMARY OF THE INVENTION

According to the present invention, dual ports at the fuel inlet of the pumping chamber bore wall are provided in conjunction with an otherwise substantially standard unit pump. A relatively small bleed port is located in spaced relation to the larger, main inlet port, thereby providing increased flexibility for controlling speed advance, fuel backup rate, and injection rate shaping.

The bleed port is located axially spaced (in the direction of pumping plunger travel) from the much larger main inlet port, otherwise known as the inlet port. The bleed port may also be radially or angularly offset relative to the inlet port to permit bleed port masking at predetermined angular orientations of the pumping plunger relative to the unit pump body. The axial spacing of the bleed port relative to the inlet port determines the distance of axial pump plunger travel between closure of the inlet port (beginning of pumping) and closure of the bleed port (end of bleed). Greater axial spacing increases the time period that the bleed port is open after closure of the inlet port. In general, the longer the bleed port is open, the greater its effect on the pressure pulse produced by the unit pump.

Under some circumstances, such as during engine startup (cranking) it is desirable that the bleed port be covered throughout the pumping cycle. An angular offset between the bleed port and inlet port permits the unit pump plunger helix to have features which mask or cover the bleed port at certain rotational positions of the plunger relative to the unit pump body. When covered, the bleed port has no effect on unit pump function.

Providing a bleed port as described above produces several beneficial effects in the operation of the unit pump and injector. First, the bleed port provides an upward shift in the engine rpm at which the speed advance phenomenon occurs. The bleed port accomplishes this by sapping energy from the first pressure wave generated by the unit pump. Thus, the first pressure wave is unable to move the unit injector needle valve until a higher engine speed, as will be further discussed below. Second, the bleed port modifies the volumetric efficiency of the unit pump in such a manner as to flatten the fuel delivery curve (reduce fuel backup). A flattened fuel delivery curve provides greater flexibility in fuel control as will be further discussed below. Third, the bleed port has a desirable effect on the rate shape of each injection pulse. By slowing or reducing the energy of the beginning of each pumping stroke, the bleed port desirably reduces the initial rate of injection of each injection pulse.

An object of the present invention is to provide a new and improved unit pump or unit injector that economically enhances control over fuel delivery through an injector.

Another object of the present invention is to provide a new and improved unit pump or unit injector that reduce emissions of nitrous oxide and smoke from internal combustion engines.

A further object of the present invention is to provide a new and improved unit pump or unit injector that reduce the effects of fuel backup on control of fuel delivery.

A yet further object of the present invention is to provide a new and improved unit pump or unit injector that permit control of the “speed advance” phenomenon.

These and other objects, features, and advantages of the invention will become readily apparent to those skilled in the art upon reading the description of the preferred embodiments, in conjunction with the accompanying drawings.

### BRIEF DESCRIPTION OF THE DRAWINGS

FIG. 1 is a sectional view through a unit pump incorporating dual ports in accordance with the present invention;

FIG. 1A is a sectional view through a portion of an internal combustion engine equipped with an injector suitable for use in conjunction with the unit pump of FIG. 1;

FIG. 2 is an exterior side view of a unit pump body illustrating one example of a dual port in accordance with the present invention;

FIG. 3 is a layout view illustrating features on the exterior surface of the pumping plunger which interact with the inlet and bleed ports, including representations of the inlet and bleed ports superimposed over the left-hand portion of the Figure;

FIG. 4 is a graph comparing unit pump fuel delivery relative to engine rpm for a unit pump with no bleed port to a unit pump with a bleed port;

FIG. 5 is a graph comparing unit pump fuel delivery relative to engine speed for a unit pump with a 0.014″ bleed port to a unit pump with a 0.018″ bleed port;

FIG. 6 is a graph comparing the SOI in engine degrees over a range of engine speeds (rpm) of a unit pump with a 0.014″ bleed port to a unit pump with a 0.018″ bleed port;

FIG. 7 is a graph comparing fuel injection rate relative to unit pump pressure and a top dead center reference over time measured in degrees of engine rotation;

FIG. 8 is a layout view of the exterior surface of a pumping plunger illustrating the helix and its upper and lower profiles with representations of the inlet and bleed ports superimposed on the helix at particular angular orientations of the pumping plunger relative to the unit pump body; and

FIG. 9 is a sectional view through a unit injector incorporating a dual port in accordance with the present invention.

### DETAILED DESCRIPTION OF THE PREFERRED EMBODIMENT

The description will be made with reference to the type of unit pump and injector described in published International Application WO 01/14728 (corresponding to U.S. application Ser. No. 09/638,758), the disclosures of which are hereby incorporated by reference. The operation of unit pumps and unit injectors are well understood and will not be discussed herein except where necessary to understand the invention.

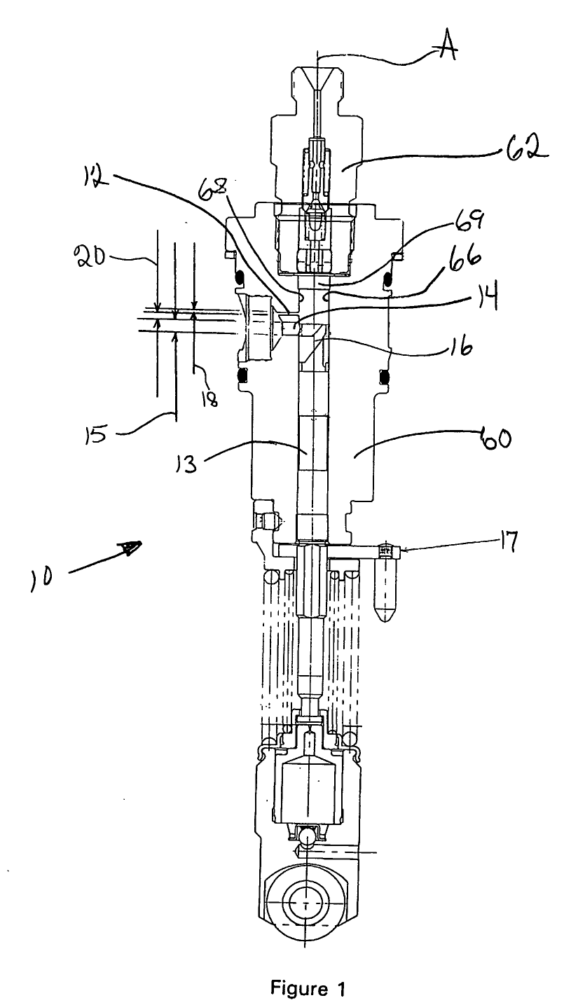

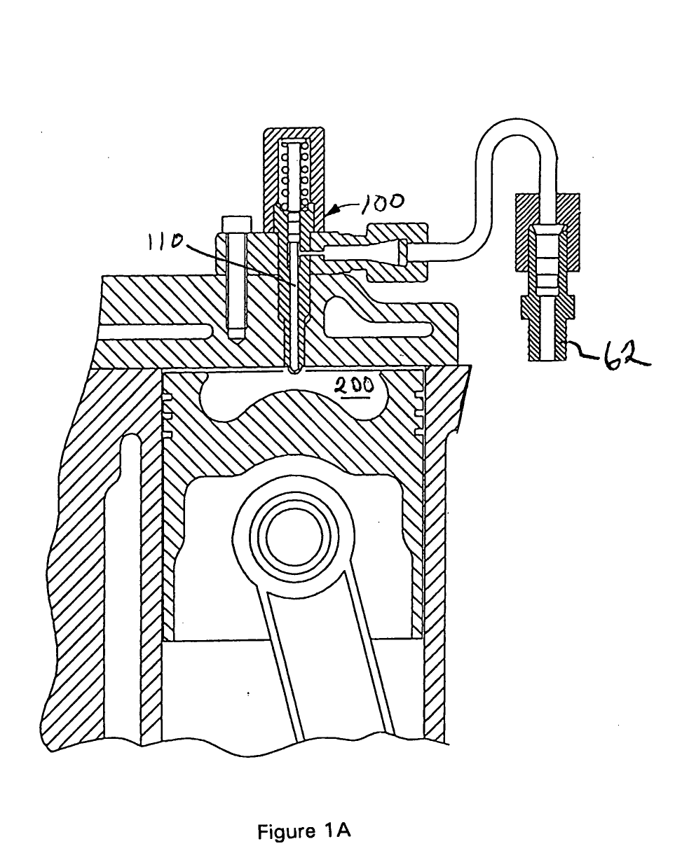

FIG. 1 is a sectional view through a unit pump assembly 10 extending from a cam follower at the bottom of the Figure through a discharge fitting 62 at the top of the Figure. A pumping plunger 13 is rotatably and reciprocably retained in a bore 66 in the unit pump body 60. A control arm 17 is attached to the pumping plunger 13 such that manipulation of the control arm rotates the pumping plunger relative to the unit pump body 60. The outside surface of the head end of the pumping plunger 13 is provided with a helix 16 whose function is to cover the inlet port (also referred to herein as the inlet port) 14 for a portion of each pumping stroke, thereby defining the duration of each pumping cycle. The basic functioning of a unit pump of this type is known in the art and will be described herein only as it relates to the present invention.

FIG. 1A illustrates an injector 100 appropriate for use in conjunction with the unit pump 10 of FIG. 1. The injector is operatively connected to a discharge fitting 62 such that high-pressure fuel produced by the unit pump acts to hydraulically open the injector needle valve 110 to produce an injection event. An injection event is characterized by the emission of a metered quantity of fuel under high pressure from the fuel injector 100 into the combustion chamber 200 of an internal combustion engine.

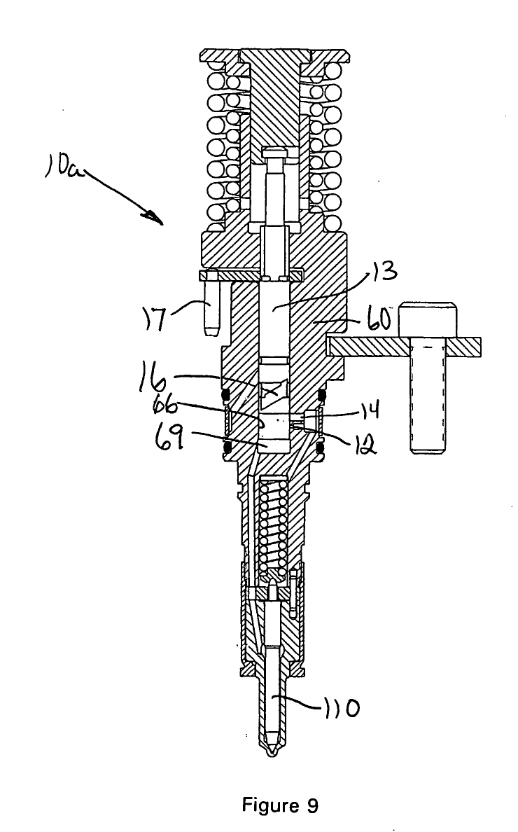

FIG. 9 is a sectional view through a unit injector 10a incorporating a dual port 12, 14 in accordance with the present invention. The unit injector 10a incorporates a unit pump and injector into a single assembly as is known in the art. Discussion of the functionality of the unit pump and dual ports 12, 14 are equally applicable to both the illustrated unit pump 10 and the unit injector 10a.

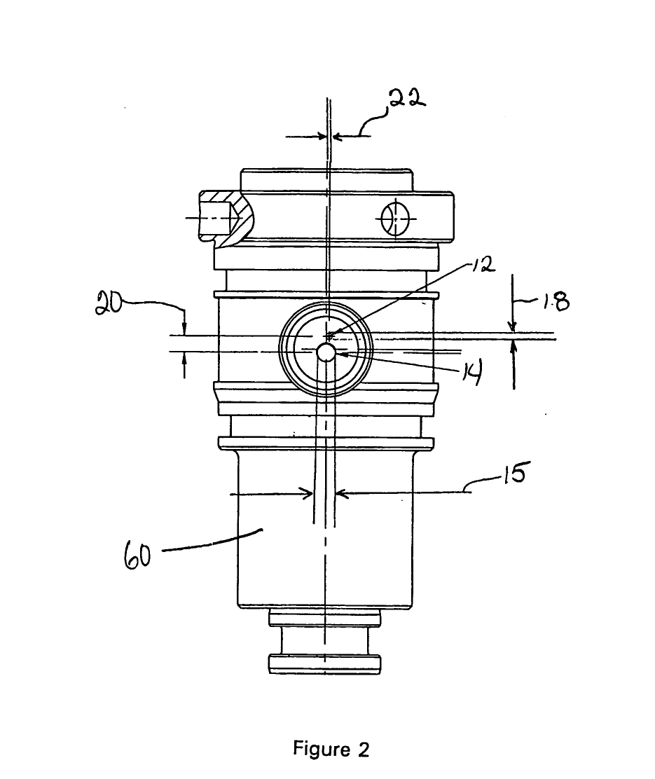

A unit pump in accordance with the present invention comprises a bleed port 12 spaced from the main inlet port 14. The bleed port 12 is positioned to be covered by the helix 16 after the inlet port 14 has been covered, or after the beginning of a pumping cycle. FIGS. 1 and 2 of the present application show the location of the bleed port 12 in conjunction with the inlet port 14 on the unit pump body 60. The bleed port 12 and inlet port 14 are shown generally laterally of the helix 16 on the pumping plunger 13 in FIG. 1. FIG. 2 illustrates one example of the relative positioning and size of the bleed port 12 relative to the inlet port 14. Design options for configuring the ports 12, 14 in accordance with the present invention include bleed port diameter 18, axial offset 20 taken with reference to the assembly axis A and angular offset 22 taken with reference to the position of the main inlet port 14.

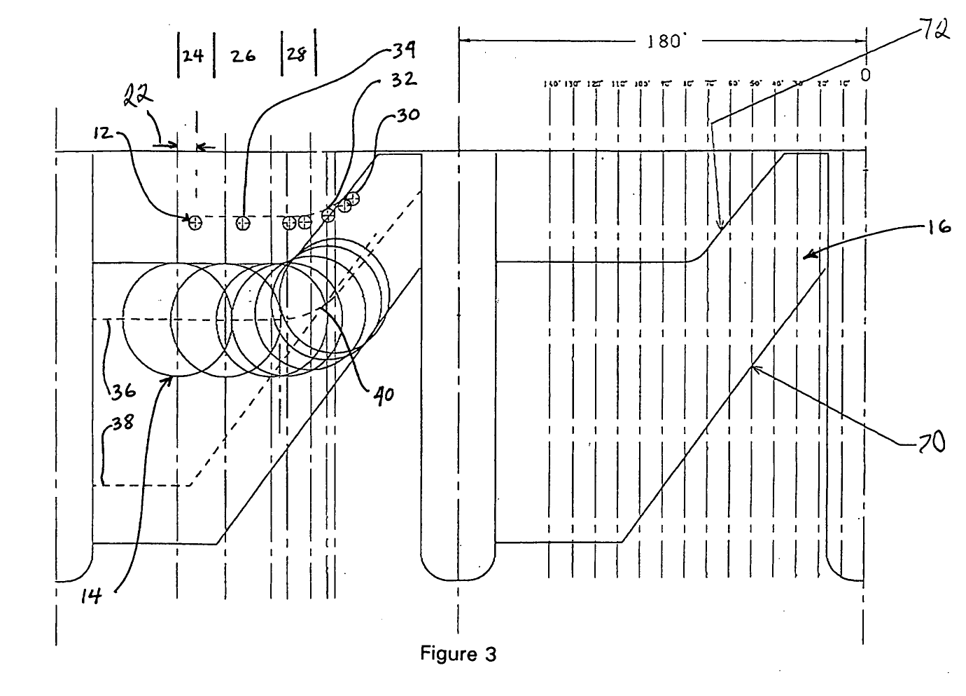

FIG. 3 is a layout view showing the relationship of the bleed port 12 in the pumping chamber wall 68 to the helix lower and upper profiles 70, 72 on the pumping plunger 13. The right hand portion of FIG. 3 illustrates 180° of the outside surface of the pumping plunger 13, clearly showing the upper and lower profiles 72, 70 of the helix 16. The left hand portion of FIG. 3 shows the bleed and inlet ports 12, 14 superimposed on the helix 16 to illustrate the relative positioning at various angular positions of the plunger 13 relative to the unit pump body.

In a known manner for adjusting the timing and duration of an injection event, the plunger 13 is rotated by manipulation of the control arm 17. Rotation of the plunger 13 changes the axial relationship of the ports 12, 14 relative to the upper and lower profiles 72, 70 of the helix 16. The full fuel region 24, throttle progression region 26 and light load advance region 28 are indicated. Depending on the advance setting, the bleed port will either be covered 30 (no leakage), transitioning 32 (with partial leakage) or totally uncovered 34 (full leakage) for returning fuel back into the entrance of the fuel inlet port 14. These conditions of the bleed port 12 affect both pressure and volume of fuel delivery in the pumping chamber 69. The lines 36, 38 represent the inlet port 14 center line at SOI and EOI, respectively, with the crossover point 40 representing the condition wherein the light load advance is, e.g., 5°.

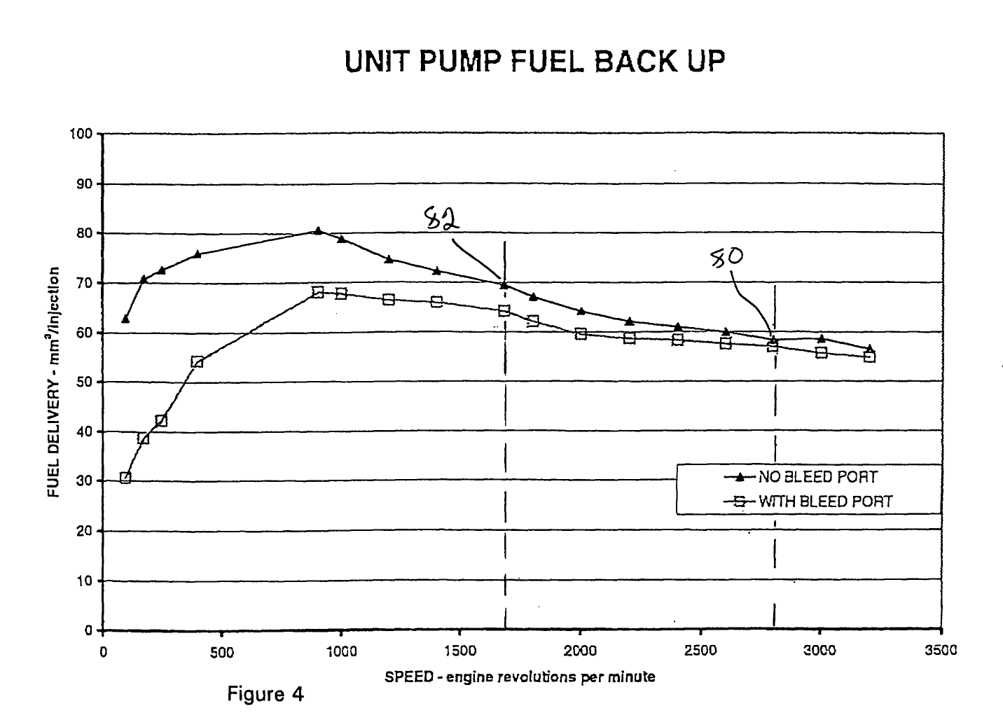

FIG. 4 illustrates the so-called “fuel backup” phenomenon that is characteristic of most pumps of any type, and is of particular significance in the design and operation of fuel injection pumps for internal combustion engines in motor vehicles. A unit pump of the type shown in FIGS. 1 and 2 may have operational characteristics such as those shown in FIG. 4, with a rated speed 80 at about 2,800 rpm, where the volumetric injection quantity is 57 mm³ per injection. As engine speed is reduced (and without any other controls or bleed port), the fuel pressure decreases and the pump in effect becomes more efficient such that the injection quantity increases to, e.g., about 70 mm³ per injection at 1,700 rpm, where peak engine torque 82 is produced. It is desirable that the slope of this curve be flattened over the engine rpm range extending between rated speed 80 and peak torque 82 or between 1,700 and 2,800 rpm. FIG. 4 illustrates how implementing the present invention (i.e., providing a bleed port) flattens the fuel backup curve.

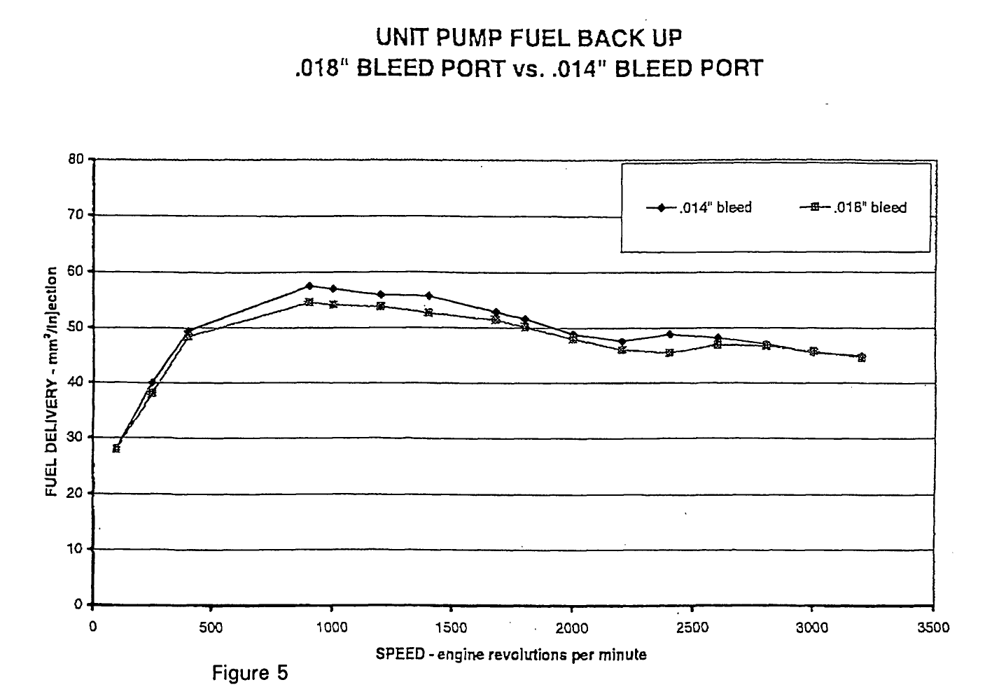

FIG. 5 graphically compares the performance of a 0.014″ (0.3556 mm) bleed port with the performance of a 0.018″ (0.4572 mm) bleed port. The larger bleed port provides a flatter fuel backup slope than the smaller bleed port.

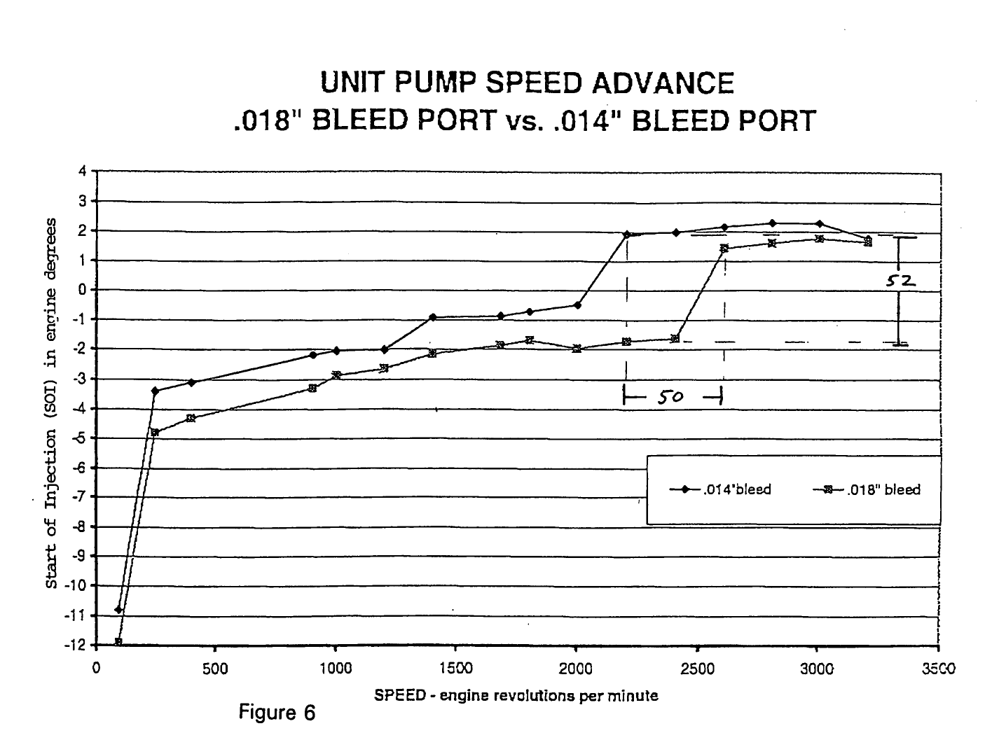

FIG. 6 graphically compares SOI in engine degrees as dependent on engine speed, for two examples of bleed port implementation (0.014″ bleed port and 0.018″ bleed port). The graph clearly shows an upward shift 50 in the engine speed at which speed advance occurs in the 0.018″ curve. The maximum advance 52 is also indicated for the 0.018″ curve. From FIG. 6 it can be seen that the size of the bleed port influences the engine speed at which speed advance occurs with speed advance occurring later with a larger bleed port.

The axial spacing 20 between the inlet port 14 and bleed port 12 also influences this effect on speed advance, with a greater axial distance 20 increasing the engine speed at which speed advance occurs. It can be seen from FIG. 6 that S0I advances approximately 3° of engine rotation in the space of approximately 100 rpm due to the first wave-second wave phenomenon previously described. Manipulation of bleed port sectional flow area (diameter 18) and axial spacing 20 permits the engine designer to control where this speed advance occurs in the engine's working rpm range.

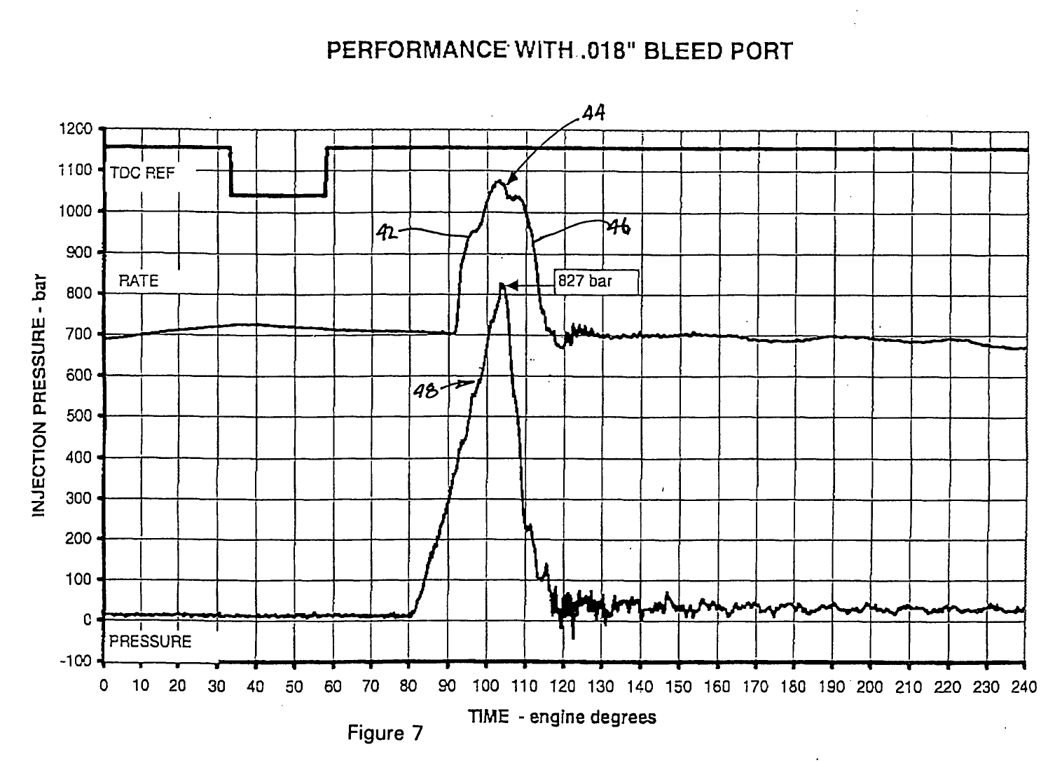

FIG. 7 is a graphical comparison of the rate shape 44 of injection for an injection pulse produced by an injector operatively connected to the representative unit pump 10 in accordance with the present invention. The rate shape of injection 44 is compared to a curve illustrating pump pressure and illustrated relative to a top dead center piston reference (TDC REF) in terms of time illustrated in degrees of engine rotation. Leakage through the bleed port at SOI softens the rise or initial rate of injection as illustrated at 42. The rapid decline in the rate of injection at 46 results from the use of a relatively large main inlet port 14. The associated pressure pulse 48 produced by the unit pump is also illustrated. Overall, the rate shape of injection 44 is improved by inclusion of a bleed port 12 in addition to the inlet port 14 in accordance with the present invention.

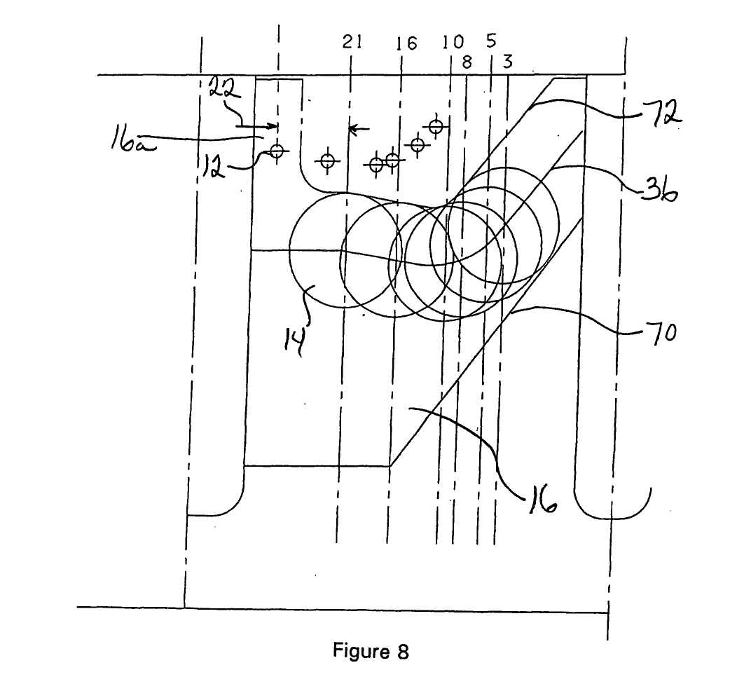

FIG. 8 is a layout view of an alternative helix shape and bleed port angular offset 22 configuration. The Figure illustrates the positions of the inlet and bleed ports 14, 12 relative to the helix upper and lower profiles 72, 70 at particular rotational positions for the plunger 13 relative to the unit pump body 60. The bleed and inlet ports 12, 14 are illustrated for each rotational position, with the rotational positions indicated by a vertical line through the center of the inlet port 14. Each vertical line through the center of the inlet port 14 is labeled with a number representing the rotational position of the pumping plunger corresponding to a control rack position stated in millimeters.

The helix 16 includes an extension 16a for masking a radially offset bleed port 12 at a plunger rotational position corresponding to a 21 mm control rack position. During cranking, it may be undesirable that the bleed port be exposed because this tends to retard SOI. Therefore, in the helix 16 and port configuration illustrated in FIG. 8, the bleed port 12 has an angular offset 22 relative to the inlet port 14. This offset permits an extension 16a of helix 16 to be positioned over the bleed port 12 at a predetermined plunger rotational position (in this case a 21 mm control rack position). This angular orientation of pumping plunger 13 relative to the unit pump body 60 is utilized only during cranking for the purpose of aligning the helix extension 16a over the bleed port 12.

In general (and with reference to FIGS. 1 and 2), for a unit pump 10 or unit injector adapted for use in a motor vehicle fuel system, the diameter of the inlet port 14 would most likely fall within the range of about 0.075″ (1.905 mm) to 0.150″(3.81 mm) and the associated bleed port diameter 18 would likely fall within the range of about 0.0075″(0.1905 mm) and 0.020″ (0.508 mm). To express this relationship in other terms, the cross-sectional flow area of the bleed port 12 would most likely fall within the range of about 1-8% of the cross sectional flow area of the inlet port at the wall 69 of the pumping bore 66. The axial offset 20 would likely fall in the range of 0.05″(1.27 mm) to 0.20″ (5.08 mm) and the radial offset 22 would likely fall in the range of 0.01″(0.254 mm) to 0.03″(0.762 mm). The radial offset could alternatively be expressed as an angular offset, which in the illustrated embodiment would likely fall in the range of 0 to 10° (degrees). These values are representative, not limiting. One implementing example has an inlet port diameter 15 of about 0.120″ (3.04 mm), a bleed port diameter 18 of about 0.016″(0.4064 mm) and an axial offset 20 of 0.10″(2.54 mm) and a radial offset 22 of about 0.020″(0.508 mm).

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. A fuel injection unit pump comprising:
a unit pump body defining a pump plunger bore, a inlet port intersecting said plunger bore and a bleed port also intersecting said plunger bore, one end of said plunger bore defining a pumping chamber, said bleed port axially spaced from said inlet port toward that end of the plunger bore defining said pumping chamber;
a pumping plunger disposed for axial reciprocation within the plunger bore and comprising a longitudinally extending circumferential surface and a pumping end;
wherein during movement of said pumping plunger toward said pumping chamber covers said inlet port with said circumferential surface to initiate a pumping cycle.

2. The fuel injection unit pump of claim 1, wherein said bleed port is angularly offset from said inlet port.

3. The fuel injection unit pump of claim 2, wherein said pumping plunger is rotatable about a longitudinal axis in said plunger bore and said circumferential surface comprises a masking feature which covers said bleed port at least contemporaneously with the covering of said inlet port during movement of said pumping plunger toward said pumping chamber.

4. The fuel injection unit pump of claim 1, wherein each of said inlet port and bleed port have a cross sectional flow area and a ratio of the cross sectional flow area of the bleed port to the cross sectional flow area of the inlet port is between 1 and 8 percent.

5. The fuel injection unit pump of claim 1, wherein said inlet port is a circular bore with a diameter between 0.075″(1.905 mm) and 0.150″(3.81 mm).

6. The fuel injection unit pump of claim 1, wherein said bleed port is a circular bore with a diameter between 0.0075″(0.1905 mm) and 0.020″ (0.508 mm).

7. The fuel injection unit pump of claim 1, wherein an axial distance between said fill/spill port and said bleed port is in the range of between 0.05″(1.27 mm) to 0.20″ (5.08 mm).

8. The fuel injection unit pump of claim 2, wherein the angular offset is in the range of 0 to 10° (degrees).

9. The fuel injection unit pump of claim 1, further comprising a fuel injector in fluid communication with a high-pressure discharge of said unit pump.

10. A method for improving the rate shape of injection through a fuel injector operatively connected to a unit pump comprising the step of:
forming a bleed orifice in a pumping chamber of the unit pump, said bleed orifice fluidly connecting said pumping chamber to a source of fuel,
wherein said bleed orifice improves the rate shape of injection by slowing the initial rate of injection.

11. The method of claim 10, comprising the step of:
adjusting the rate shape of injection by varying a cross sectional flow area of said bleed orifice,
wherein increasing said cross sectional flow area decreases the initial rate of injection and decreasing said cross sectional flow area increases the initial rate of injection.

12. The method of claim 10, comprising the step of:
adjusting the rate shape of injection by varying an axial distance between said bleed orifice and a main fuel inlet port of said unit pump,
wherein increasing said axial distance decreases the initial rate of injection and decreasing said axial distance increases the initial rate of injection.

13. A method for delaying speed advance in fuel delivery through a fuel injector operatively connected to a unit pump comprising the step of:
forming a bleed orifice in a pumping chamber of the unit pump, said bleed orifice fluidly connecting said pumping chamber to a source of fuel and axially spaced from a main fuel inlet,
wherein said bleed orifice delays speed advance in fuel delivery by removing energy from a first pressure wave generated by said unit pump.

14. The method of claim 13, comprising the step of:
adjusting an engine rotational speed at which speed advance occurs by varying the cross sectional flow area of said bleed orifice,
wherein increasing said cross sectional flow area increases the engine rotational speed at which speed advance occurs and decreasing said cross sectional flow area decreases the engine rotational speed at which speed advance occurs.

15. A method for reducing fuel backup in a unit pump comprising the step of:
forming a bleed orifice in a pumping chamber of the unit pump, said bleed orifice fluidly connecting said pumping chamber to a source of fuel and axially spaced from a main fuel inlet,
wherein said bleed orifice reduces fuel backup by bleeding more fuel from said pumping chamber at lower engine rotational speeds than at higher engine rotational speeds.

16. The method of claim 15, comprising the step of:
adjusting the reduction in fuel backup of the bleed orifice on fuel backup by varying a cross sectional flow area of said bleed orifice,
wherein increasing said cross sectional flow area increases the reduction in fuel backup and decreasing said cross sectional flow area decreases the reduction in fuel backup.

17. The method of claim 15, comprising the step of:
adjusting the reduction in fuel backup of the bleed orifice on fuel backup by varying the axial distance between said bleed orifice and said main fuel inlet port,
wherein increasing said axial distance increases the reduction in fuel backup and decreasing said axial distance decreases the reduction in fuel backup.
